(19) United States
(12) Patent Application Publication
(10) Pub. No.: US 2009/0072698 A1
(43) Pub. Date: Mar. 19, 2009

(54) Microwave coupled excitation of solid state resonant arrays

(75) Inventors: Michael Maines, Gainesville, FL (US); Narada Bradman, Gainesville, FL (US); Mark Davidson, Florahome, FL (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Virgin Islands Microsystems, Inc., Saint Thomas, FL (US)

(21) Appl. No.: 12/213,449

(22) Filed: Jun. 19, 2008

Related U.S. Application Data
(60) Provisional application No. 60/929,265, filed on Jun. 19, 2007.

(51) Int. Cl. F21K 7/00

(52) U.S. Cl. 313/358

(57) ABSTRACT

An electronic receiver array for detecting microwave signals. Ultra-small resonant devices resonate at a frequency higher than the microwave frequency (for example, the optical frequencies) when the microwave energy is incident to the receiver. A microwave antenna couples the microwave energy and excites the ultra-small resonant structures to produce Plasmon activity on the surfaces of the resonant structures. The Plasmon activity produces detectable electromagnetic radiation at the resonant frequency.

### CROSS-REFERENCE TO RELATED APPLICATIONS

The present invention is related to the following co-pending U.S. patent applications which are all commonly owned with the present application:
1. U.S. patent application Ser. No. 11/238,991, entitled “Ultra-Small Resonating Charged Particle Beam Modulator,” filed Sep. 30, 2005;
2. U.S. patent application Ser. No. 10/917,511, entitled “Patterning Thin Metal Film by Dry Reactive Ion Etching,” filed on Aug. 13, 2004;
3. U.S. application Ser. No. 11/203,407, entitled “Method Of Patterning Ultra-Small Structures,” filed on Aug. 15, 2005;
4. U.S. application Ser. No. 11/243,476, entitled “Structures And Methods For Coupling Energy From An Electromagnetic Wave,” filed on Oct. 5, 2005;
5. U.S. application Ser. No. 11/243,477, entitled “Electron beam induced resonance,” filed on Oct. 5, 2005;
6. U.S. application Ser. No. 11/325,448, entitled “Selectable Frequency Light Emitter from Single Metal Layer,” filed Jan. 5, 2006;
7. U.S. application Ser. No. 11/325,432, entitled, “Matrix Array Display,” filed Jan. 5, 2006;
8. U.S. application Ser. No. 11/302,471, entitled “Coupled Nano-Resonating Energy Emitting Structures,” filed Dec. 14, 2005;
9. U.S. application Ser. No. 11/325,571, entitled “Switching Micro-resonant Structures by Modulating a Beam of Charged Particles,” filed Jan. 5, 2006;
10. U.S. application Ser. No. 11/325,534, entitled “Switching Microresonant Structures Using at Least One Director,” filed Jan. 5, 2006;
11. U.S. application Ser. No. 11/350,812, entitled “Conductive Polymers for Electroplating,” filed Feb. 10, 2006;
12. U.S. application Ser. No. 11/349,963, entitled “Method and Structure for Coupling Two Microcircuits,” filed Feb. 9, 2006;
13. U.S. application Ser. No. 11/353,208, entitled “Electron Beam Induced Resonance,” filed Feb. 14, 2006;
14. U.S. application Ser. No. 11/400,280, entitled “Resonant Detectors for Optical Signals,” filed Apr. 10, 2006 (Attorney Docket No. 2549-0068);
15. U.S. application Ser. No. 11/410,924, entitled “Selectable Frequency EMR Emitter,” filed Apr. 26, 2006 (Attorney Docket No. 2549-0010); and
16. U.S. application Ser. No. 11/411,129, entitled “Micro Free Electron Laser (FEL),” filed Apr. 26, 2006 (Attorney Docket No. 2549-0005).

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD OF THE DISCLOSURE

This relates in general to an array of receivers that couple energy between electromagnetic radiation (typically, but not necessarily, optical radiation) and an excitation source.

### INTRODUCTION

In the related applications described above, micro- and nano-resonant structures are described that react in now-predictable manners when an electron beam is passed in their proximity. Those structures can be formed into groups, or arrays, that allow energy from the electron beam to be converted into the energy of electromagnetic radiation (light) when the electron beam passes nearby. Alternatively, those structures can receive incident electromagnetic radiation (light) and alter a characteristic of the electron beam in a way that can be detected. When the electron beam passes near the structure, it excites synchronized oscillations of the electrons in the structure (surface Plasmon) and/or electrons in the beam. Those excitations can result in reemission of detectable photons as electromagnetic radiation (EMR). The ability to couple energy either into a charged particle beam from light and from a charged particle beam into light has many advantageous applications including, but not limited to, efficient light production, digital signal processing, and receiver array surveillance.

In one or more of the above-referenced prior applications, ultra-small resonant structures were described that have particular interactions upon an electron beam when light was made incident upon them. As shown in FIG. 5, a light receiver 10 can include ultra-small resonant structures 12, such as any one of the ultra-small resonant structures described in U.S. patent application Ser. Nos. 11/238,991; 11/243,476; 11/243,477; 11/325,448; 11/325,432; 11/302,471; 11/325,571; 11/325,534; 11/349,963; and/or 11/353,208 (each of which is identified more particularly above). The resonant structures can be manufactured in accordance with any of U.S. application Ser. Nos. 10/917,511; 11/350,812; or 11/203,407 (each of which is identified more particularly above) or in other ways. Their sizes and dimensions can be selected in accordance with the principles described in those applications and, for the sake of brevity, will not be repeated herein. The contents of the applications described above are assumed to be known to the reader.

In the example of FIG. 5, the receiver 10 includes cathode 20, anode 19, optional energy anode 23, ultra-small resonant structures 12, Faraday cup or other receiving electrode 14, electrode 24, and differential current detector 16.

When the receiver 10 is not being stimulated by encoded light 15, the cathode 20 produces an electron beam 13, which is steered and focused by anode 19 and accelerated by energy anode 23. The electron beam 13 is directed to pass close to but not touching one or more ultra-small resonant structures 12. In this sense, the beam needs to be only proximate enough to the ultra-small resonant structures 12 to invoke detectable electron beam modifications. After the anode 19, the electron beam 13 passes energy anode 23, which further accelerates the electrons in known fashion. When the resonant structures 12 are not receiving the encoded light 15, then the electron beam 13 passes by the resonant structures 12 with the structures 12 having no significant effect on the path of the electron beam 13. The electron beam 13 thus follows, in general, the path 13b and is received by a Faraday cup or other detector electrode 14.

When, however, the encoded light 15 is induced on the resonant structures 12, the encoded light 15 induces surface plasmons to resonate on the resonant structures 12. The ability of the encoded light 15 to induce the surface plasmons is described in one or more of the above applications and is not repeated herein. The electron beam 13 is impacted by the surface plasmon effect causing the electron beam to steer away from path 13b (into the Faraday cup) and into alternative path 13a or 13c, which can be detected by differential current detector 16.

As the term is used herein, the structures are considered ultra-small when they embody at least one dimension that is smaller than the wavelength of the electromagnetic radiation that they are detecting (in the case of FIG. 5, the wavelength of visible light). The ultra-small structures are employed in a vacuum environment. Methods of evacuating the environment where the beam 13 passes by the structures 12 can be selected from known evacuation methods.

With consideration to the solid state resonant arrays described in the related applications, it may be prudent in a wide range of applications to utilize coupled microwave energy as an excitation source. Currently, one proposed method for excitation is a hardwired/driven signal transmitted via electrically connected pads. Although this case has its applications under the conditions of low drive frequency and given that signal transmission/coupling can still excite the devices, there may be alternative applications that may not be optimized from this arrangement. For the benefit of increased coupling, it may be possible to incorporate a microwave antenna to provide energy coupling and excitation to the Solid State Resonant Arrays.

### BRIEF DESCRIPTION OF THE DRAWINGS

FIG. 1 is a simplified schematic view of a microwave strip antenna for use with Solid State Resonant Arrays;

FIG. 2 is an alternative simplified schematic view of a microwave spiral antenna for use with Solid State Resonant Arrays;

FIG. 3 is another alternative simplified schematic view of a microwave spiral antenna for use with Solid State Resonant Arrays;

FIG. 4 is another alternative simplified schematic view of a microwave concentric circle antenna for use with Solid State Resonant Arrays; and

FIG. 5 is an example schematic of a charged particle beam antenna described in the related applications.

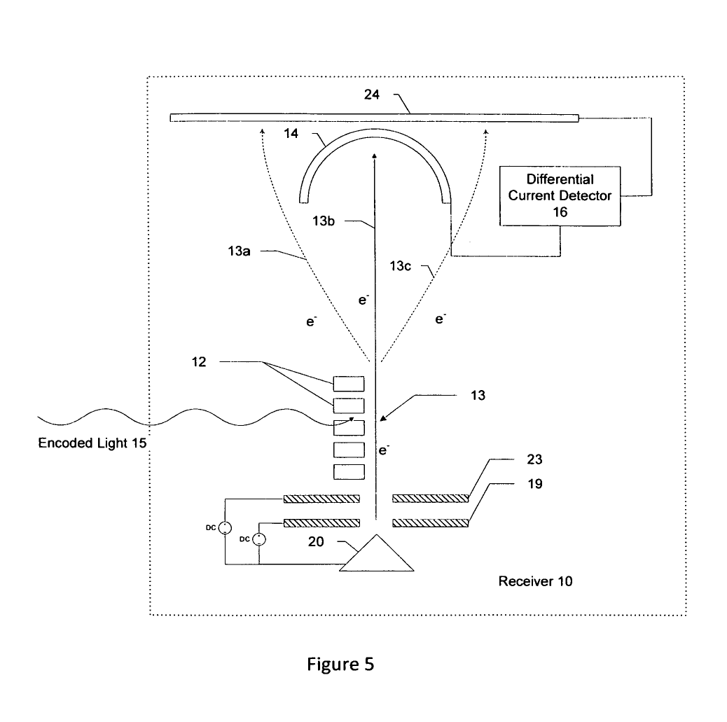

### THE PRESENTLY PREFERRED EXEMPLARY EMBODIMENTS

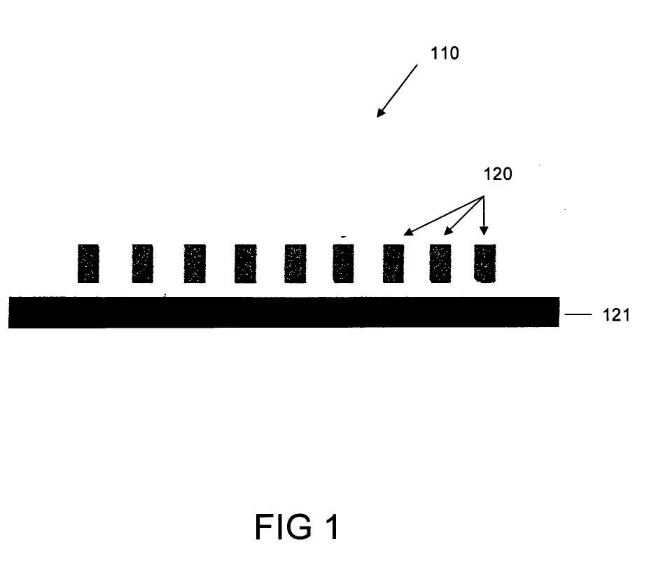

The present systems detect microwave energy and convert it into optical (or other higher-than-optical frequency) energy. A simple microwave antenna for use with solid state resonant arrays is shown in FIG. 1. There, a strip antenna 110 includes a microwave antenna 121 of known type arranged near ultra-small resonant structures 120 of the solid state resonant array. In the manner described in the above-referenced applications, the ultra-small resonant structures are designed to emit electromagnetic radiation at a frequency higher than the microwave frequency using very small structures having a physical dimension less that the frequency of the emitted radiation. In the case of emitted optical radiation, the structures have a physical dimension less than the wavelength of the emitted light.

As the microwave antenna 121 is excited, an electromagnetic field profile based on the excitation signal is coupled and transmitted along the microwave antenna 121. The excitation signal can produce plasmon excitation on the ultra-small resonant structures 120 of the solid state resonant array, which based on their configuration, will emit their optical radiation at the designed wavelength.

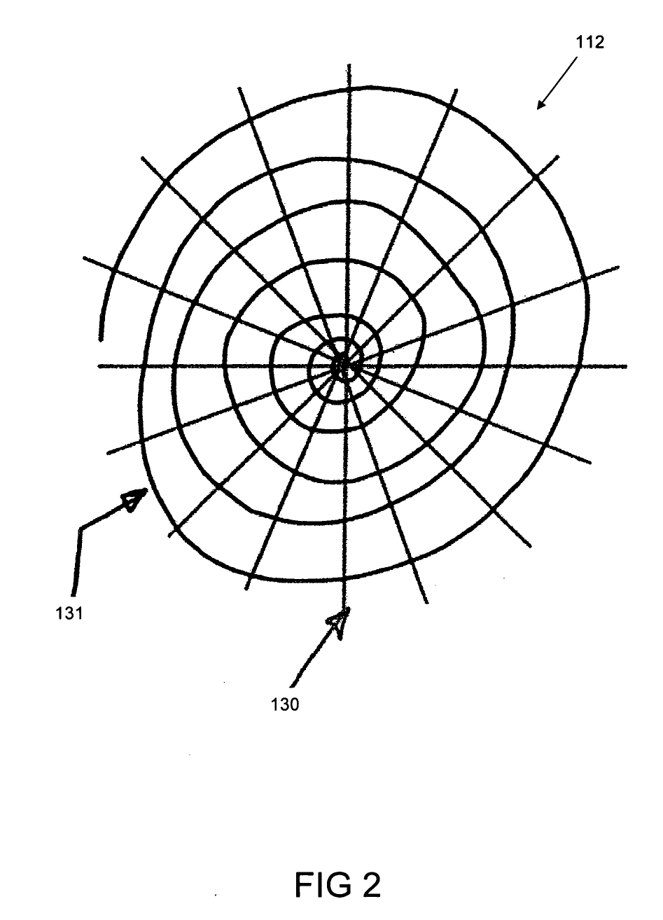

Alternatively, the microwave antenna could be constructed in more elegant ways so as to excite many arrays at a time. One example is the spiral antenna 112 of FIG. 2. There, several lines of arrays 130 extend outwardly from a central point. The microwave antenna 131 spirals out from that central point beneath the lines of arrays 130.

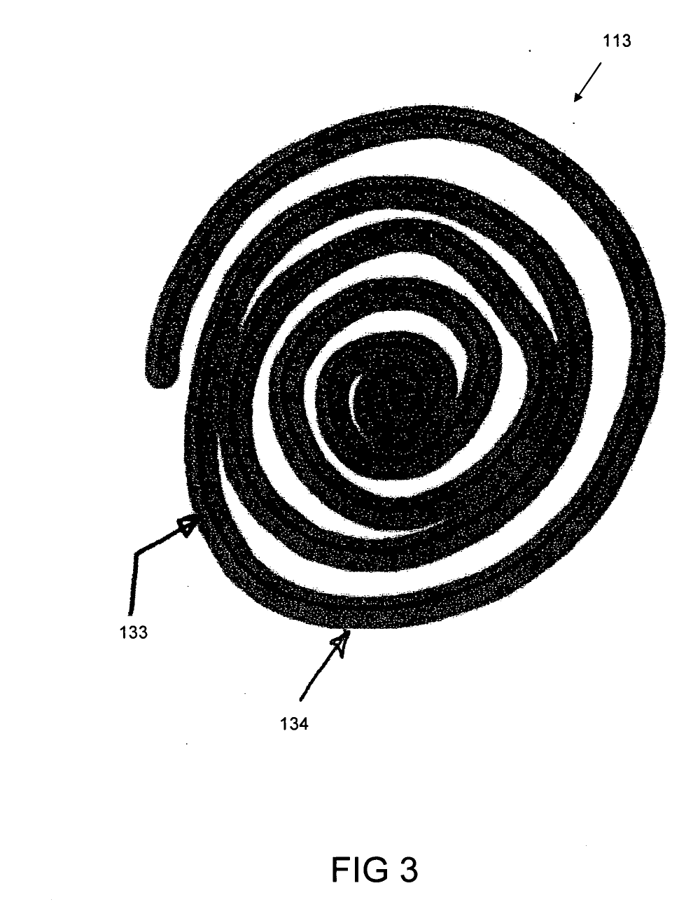

Other variations on the array alignment and orientation are also of importance, and will be dependent on the application. Yet another example antenna 113 is shown in FIG. 3, in which the spiral-shaped microwave antenna 133 originates at the same central point, but the arrays are not formed in lines as in FIG. 2. Instead, the arrays 134 follow the path of the microwave antenna 133 to couple the microwave energy by their proximity to the edges of the antenna 133.

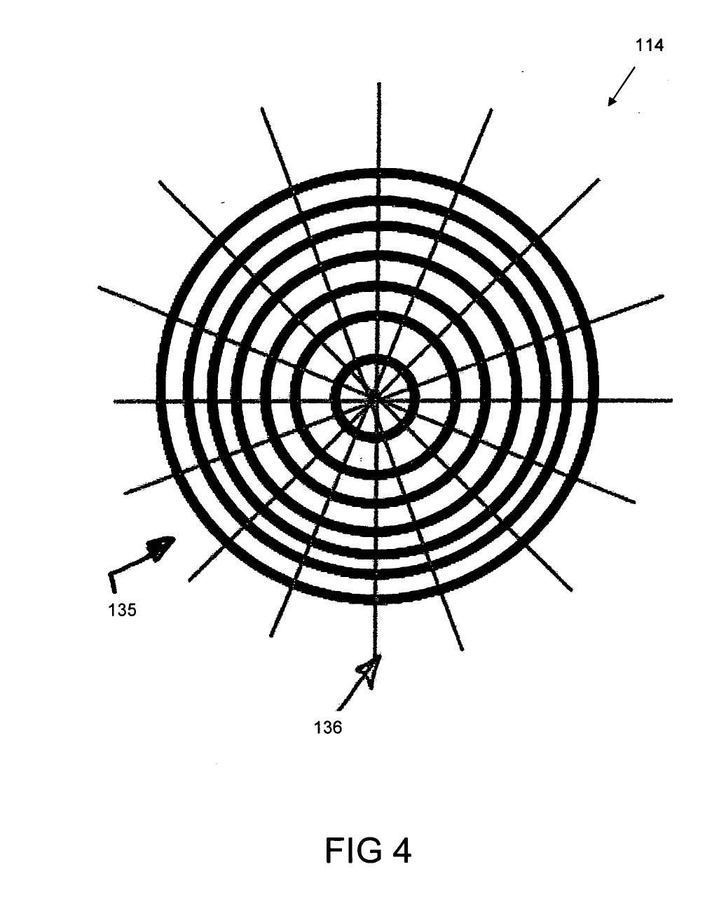

In addition to being used as a single wavelength resonant device, the detection device 114 of FIG. 4 represents a microwave antenna 135 that will couple a different frequency of microwave energy to a separate area of solid state resonant arrays 136. Thus, the size, length, arrangement and periodicity of the ultra-small resonant structures can be altered to tune different lines of the arrays 136 to different microwave frequencies. With a number of solid state resonant arrays 136 designed for a number of frequencies, essentially conversion of any microwave frequency to optical wavelength output is possible.

What is claimed is:

1. A receiver array to detect microwave radiation, comprising:
a microwave antenna; and
an array of solid state resonant structures proximate to but not touching the microwave antenna to couple energy from the microwave antenna to the resonant structures to thereby produce resonant Plasmon activity on the surfaces of the resonant structures at a resonant frequency higher than the microwave frequency, the solid state resonant structures in the array being arranged in a path spaced apart from each other in a vacuum environment and having a physical dimension less than said wavelength of the resonant frequency higher than the microwave frequency.

2. The receiver according to claim 1 wherein the microwave antenna is in the form of a spiral.

3. The receiver according to claim 2 wherein the spiral defines a center and the array of solid state resonant structures proceeds outwardly from the center.

4. The receiver according to claim 2 wherein the spiral defines a center and the array of solid sate resonant structures includes multiple lines of solid state resonant structures, wherein each line of solid state resonant structures proceeds outwardly from the center.

5. The receiver according to claim 2 wherein the array is arranged to trace at least a portion of the spiral.

6. The receiver according to claim 1 wherein the microwave antenna is in the form of concentric circles.

7. The receiver according to claim 6 wherein the concentric circles define a center and the array of solid sate resonant structures includes multiple lines of solid state resonant structures, wherein each line of solid state resonant structures proceeds outwardly from the center.

8. The receiver according to claim 7 wherein each line of solid state resonant structures is tuned to a different microwave frequency.

9. The receiver according to claim 7 wherein at least two of the lines of solid state resonant structures are tuned to different microwave frequencies.

10. The receiver according to claim 1, wherein the resonant Plasmon activity on the surfaces of the resonant structures is synchronized oscillations of electrons on the surfaces of the resonant structures.

11. A system, comprising:
a microwave excitation source producing microwave energy;
a microwave antenna to receive the microwave energy; and
an array of solid state resonant structures to couple the microwave energy from the microwave antenna to the resonant structures to thereby produce resonant Plasmon activity on the surfaces of the resonant structures at a resonant frequency higher than the microwave frequency, the solid state resonant structures in the array being arranged in a path spaced apart from each other in a vacuum environment and having a physical dimension less than said wavelength of the resonant frequency higher than the microwave frequency.

12. The receiver according to claim 11 wherein the microwave antenna is in the form of a spiral.

13. The receiver according to claim 12 wherein the spiral defines a center and the array of solid state resonant structures proceeds outwardly from the center.

14. The receiver according to claim 12 wherein the spiral defines a center and the array of solid sate resonant structures includes multiple lines of solid state resonant structures, wherein each line of solid state resonant structures proceeds outwardly from the center.

15. The receiver according to claim 12 wherein the array is arranged to trace at least a portion of the spiral.

16. The receiver according to claim 11 wherein the microwave antenna is in the form of concentric circles.

17. The receiver according to claim 16 wherein the concentric circles define a center and the array of solid sate resonant structures includes multiple lines of solid state resonant structures, wherein each line of solid state resonant structures proceeds outwardly from the center.

18. The receiver according to claim 17 wherein each line of solid state resonant structures is tuned to a different microwave frequency.

19. The receiver according to claim 17 wherein at least two of the lines of solid state resonant structures are tuned to different microwave frequencies.

20. The receiver according to claim 11, wherein the resonant Plasmon activity on the surfaces of the resonant structures is synchronized oscillations of electrons on the surfaces of the resonant structures.
